(19) United States
(12) Patent Application Publication
(10) Pub. No.: US 2005/0011539 A1
(43) Pub. Date: Jan. 20, 2005

(54) Device and method for collecting wastewater in dishwashers

(75) Inventors: Heinz-Werner Giefer, Sontheim (DE); Georg Hechtl, Dillingen (DE); Hans-Peter Nannt, Dettingen (DE); Horst Sipple, Giengen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/879,929

(22) Filed: Jun. 28, 2004

(30) Foreign Application Priority Data
Nov. 26, 2002 (WO) PCT/EP02/13316
Dec. 28, 2001 (DE) DE 101 64 507.4

(51) Int. Cl. B08B 3/00

(52) U.S. Cl. 134/25.2; 134/57 D; 134/111; 134/186

(57) ABSTRACT

A device for collecting waste water in a dishwashing machine. The device includes a pump well and a sump section, with the sump section communicating with the pump well in the lower regions of the dishwashing machine through an inflow section. The device also contains a valve located in or operating with the inflow section that blocks the influx of waste water from the pump well into the sump section when the valve is closed. The valve allows the influx of waste water from the pump well into the sump section when the valve is opened.

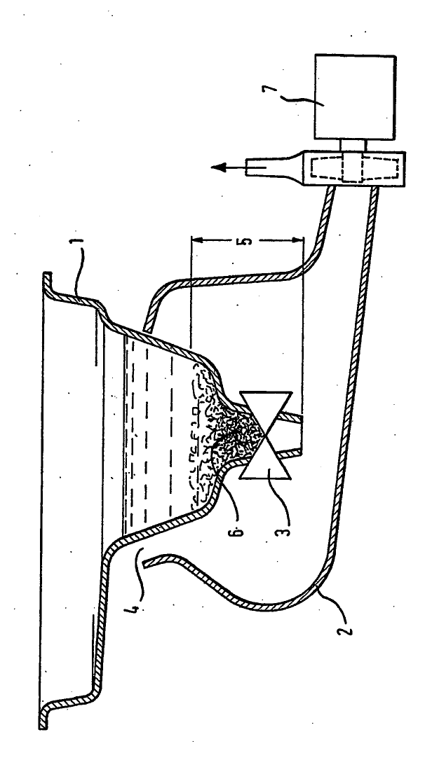

The object of the present invention is a device for collecting wastewater in dishwashing machines with a pump well and a sump section arranged in its lower region, which is connected via an inflow section to the pump well, and a method for collecting wastewater in a dishwashing machine.

DE 30 33 026 A1 discloses a dishwashing machine for carrying out a method for removing food residues, whereby a sump floor is provided in the lower region of a pump well, which has in its lower region a sump section, connected via an inflow section to the pump well. The result of different structures on the sump wall of the sump floor should be to cause a rotation of the liquid contained therein containing food residues, with the result that the more solid constituents, i.e. the food residues in the waste water are moved to the rotation point in accordance with physical laws. Located in the rotation point finally is the inflow section leading from the pump well to the sump section, where the sump section is connected to an emptying pump. In order to convey the food residues sinking to the sump floor during circulating of the washing liquid faster to the opening in the suction connection of the emptying pump located in the sump floor, and, to prevent food residues gathered there from whirling up, guide elements for the washing liquid are provided on the sump floor aligned axially, tangentially or helically to the centre of the floor, for example.

This device has proven to be disadvantageous, in that separate means (pumps, for example) must be provided to introduce the cyclic flow, and the wastewater in the pump well containing food residues must be completely emptied for cleaning.

The object of the present therefore is to provide a device and a method for collecting waste water in dishwashing machines of the type described at the outset, which enables reliable separation of waste water containing food residues, in order to finally substantially reduce the water consumption of dishwashing machines.

This task is solved according to the present invention by a device for collecting wastewater in dishwashing machines having the characteristics of claim 1 and by the inventive method for collecting wastewater in a dishwashing machine having the characteristics of claim 5. Advantageous further developments of the present invention are characterised in the independent claims.

The average water consumption during a wash cycle can be drastically reduced by using the inventive device for collecting waste water in dishwashing machines, because only the waste water contaminated with food residues is conveyed to the lye pump and discharged, while the waste water only slightly contaminated with food residues is lead to the circulating pump and can flow back again into the liquid cycle.

At the beginning of a wash cycle the coarse and light detachable food residues clinging to crockery are loosened by the effect of water jets and sent down to the pump well. With the inventive device for collecting wastewater in dishwashing machines the food residues sinking in the pump well are guided through precise opening and closing of a valve located in a sump section under the pump well and discharged there via a lye pump. The wastewater remaining in the pump well now contains only smaller floating dirt particles, which can be recirculated into the wash cycle via the circulating pump.

In a particularly advantageous embodiment of the inventive device for collecting waste water in dishwashing machines the valve arranged in the inflow section to the sump section is also controlled during the circulation procedure to convey those dirt particles, for example only later loosened from crockery or cutlery, which have sunk to the floor of the pump well, into the subjacent sump section. Effectively a vent, which provides pressure equalisation in the sump section, is provided in the sump section, since the circulating or lye pump would quickly generate subpressure in the sump section if the valve were closed, which could negatively influence both the efficiency of the pumps and the materials of the sump body being used, in particular when larger volumes of liquid are being suctioned off.

In a particularly advantageous manner the valve of the inventive device for collecting waste water in dishwashing machines is designed to be controlled by the wash cycle, so that for example when a wash cycle for particularly soiled loads is actuated a wait is made for numerous food residues to sink into the pump well or this is repeatedly carried out to suction off these accumulated food residues through the sluice-like sump section.

According to the inventive method for collecting waste water in dishwashing machines, in particular using an inventive device for collecting waste water in dishwashing machines the waste water collects in a pump well, which is connected to a sump section arranged underneath via a valve into an inflow section, and this valve is opened or blocked as required to let at least a partial quantity of the waste water to flow into the sump section, and at least this accumulated partial quantity of waste water is pumped out via a lye or circulating pump, thus drastically reducing the average water consumption during a wash cycle, because only the waste water contaminated with food residues is lead to the lye pump and discharged, while the waste water contaminated only slightly with food residues is lead to the circulating pump and can recirculate to the washing cycle.

The present invention has succeeded in providing a device and a method for collecting waste water in dishwashing machines of the type described at the outset, which enables reliable separation of waste water containing food residues in order to substantially reduce the water consumption of dishwashing machines.

A preferred embodiment of the invention is described in greater detail hereinbelow by means of a diagram. The sole figure shows a schematic cross-section through a pump well and a sump section situated below to which a circulating/lye pump is connected.

At the beginning of a wash cycle the coarse and easily loosened food residues clinging to the crockery and as the wash cycle continues the more stubborn food residues are also naturally loosened by the effect of water jets. After the food residues clinging to the items to be washed they sink down on account of gravity and form a sump 6 in the pump well 1. Depending on the quantity of food residues the inflow section 5 in the lower region of the pump well 1 fills up accordingly with food residues. From a certain quantity or depending on a preset interval the valve 3 is opened and remains open according to a predetermined time, which is fixed in the wash cycle, in order to supply the sump 6, in particular the sump 6 containing food residues from the pump well 1 to the sump section 2. As soon as this sump 6 has been supplied from the pump well 1 into the sump section 2 through the inflow section 5, the valve 3 closes. The sump 6 located in the sump section 2 is pumped out by the pumping function (lye pump function) of the circulating/lye pump 7. From now on the valve 3 can be reopened and wastewater containing only minimal food residues can be recycled through the circulating pump function of the circulating/lye pump 7 to the wash cycle. To avoid subpressure situations in the sump section 2 the latter has a vent 4, which ensures in particular that both the circulating/lye pump 7 and the material of the sump section 2 is not stressed unnecessarily when larger volumes of waste water are being suctioned off in the contamination region 2. Alternatively two separate pumps can be provided instead of a combined circulating/lye pump 7.

The present invention has succeeded in providing a device and a method for collecting waste water in dishwashing machines of the type described at the outset, which enables reliable separation of waste water containing food residues in order to substantially reduce the water consumption of dishwashing machines.

1.-5. (canceled)

6. A device for collecting waste water in a dishwashing machine, comprising:
the dishwashing machine including a pump well and a sump section communicating with said pump well in a lower region of said dishwashing machine;
said sump section communicating with said pump well via an inflow section; and
a valve located in or operative with said inflow section, said valve blocking the influx of waste water from said pump well into said sump section when said valve is closed and said valve allowing the influx of waste water from said pump well into said sump section when said valve is open.

7. The device according to claim 6, including said sump section including a vent for pressure equalization between said sump section and the exterior of said sump section.

8. The device according to claim 6, including at least one of a lye pump and/or a circulating pump is attached to said sump section.

9. The device according to claim 6, including said valve controlled via the washing cycle of said dishwashing machine.

10. A method for collecting waste water in a dishwashing machine, comprising:
collecting the waste water in a pump well provided in the dishwashing machine;
coupling said pump well with a sump section and locating said sump section below said pump well;
coupling said pump well with said sump section through a inflow section;
controlling said waste water flow from said pump well into said sump section;
blocking said waste water flow from said pump well into said sump section by closing said valve;
allowing a partial quantity of said waste water to flow from said pump well into said sump section by opening said valve; and
pumping said partial quantity of said waste water out of said sump section via at least one of a lye pump or a circulating pump.
